(19) United States
(12) Patent Application Publication
(10) Pub. No.: US 2019/0242165 A1
(43) Pub. Date: Aug. 8, 2019

(54) Exterior Door Handle for a Motor Vehicle

(71) Applicant: Huf Hülsbeck & Fürst GmbH & Co. KG, Velbert (DE)

(72) Inventor: Sebastian Gebel, Koln (DE)

(21) Appl. No.: 16/329,782

(22) PCT Filed: Aug. 14, 2017
(86) PCT No.: PCT/EP2017/070639

§ 371 Date: Mar. 1, 2019

(30) Foreign Application Priority Data
Sep. 2, 2016 (DE) 10 2016 116 462.3

(51) Int. Cl. E05C 19/02; E05B 17/18; E05C 19/04; E05B 85/06; E05B 85/10

(52) U.S. Cl. CPC E05C 19/022; E05B 17/183; E05C 19/04; E05Y 2900/531; E05B 85/103; E05B 85/107; E05B 85/06

(57) ABSTRACT

An exterior door handle for a motor vehicle is assigned a functional component, which can be covered by a covering element, the covering element being arranged on a motor vehicle door, in particular on a bearing bracket connected to the motor vehicle door, the covering element having an operating section which is visible to a user from the outside. When the covering element is in the closed state, the functional component is inaccessible to the user, and when the covering element is in an open state, the functional component is accessible to a user. An actuator which is arranged on the motor vehicle door, in particular on the bearing bracket, is provided to move the covering element, and, when the covering element is in the closed state, the operating section can be operated by the user to activate the actuator.

### CROSS-REFERENCE TO RELATED APPLICATIONS

This application claims priority under 35 U.S.C. § 371 to Patent Cooperation Treaty Application No. PCT/EP2017/070639, filed Aug. 17, 2017, which claims priority to DE Application No. 102016116462.3, filed Sep. 2, 2016, the contents of which are incorporated herein by reference in their entirety.

### FIELD

The invention relates to an exterior door handle for a motor vehicle, which is assigned a functional component, which can be covered by a covering element, the covering element being arranged on a motor vehicle door, in particular on a bearing bracket connected to the motor vehicle door, the covering element having an operating section which is visible to a user from the outside. When the covering element is in the closed state, the functional component is inaccessible to the user, and when the covering element is in an open state, the functional component is accessible to a user.

### BACKGROUND

This section provides background information related to the present disclosure and is not necessarily prior art.

From prior art an exterior door handle is known for a vehicle, which is assigned a covering element, which covers a lock cylinder. The covering element is attached on a vehicle door. To have access to the lock cylinder, a user must remove the covering element. The covering element is unclipped from the vehicle door using a wrench. For this the covering element has a recess, into which the shaft of the wrench can be inserted. However, the drawback is that the user needs an additional part such as a wrench. Additionally, when using the wrench, the covering element can be damaged, as well.

### SUMMARY

This section provides a general summary of the disclosure, and is not a comprehensive disclosure of its full scope or all of its features.

One aspect of the present disclosure configures for a user a convenient access to the lock cylinder.

In some implementations, an actuator, arranged on the vehicle door, especially on the bearing bracket, for moving the covering element, and the operating section is operable by the user in the closed state of the covering element for actuation of the actuator. Advantageously, the actuator serves as an actuator for the covering element, so that it is possible to move the covering element without additional means or tools. The user merely needs to actuate the operating section visible from outside and the actuator is activated, so that the covering element is moved over from the locked state into another state. Correspondingly, it suffices if the user uses his hand to operate the operating section, preferably by pushing the operating section toward the interior of the vehicle. By pushing the operating section, automatically the actuator is activated, and takes care of moving the covering element. This simple manipulation and operating of the covering element ensures that during operation of the covering element, damage to the outer door handle and the covering element is precluded. This results in increased convenience for the user when operating the covering element.

According to a preferred embodiment of the exterior door handle, provision can be made that at least in the closed state, the covering element is coupled with the actuator. This ensures that when operating the operating section of the covering element, the actuator is reliably activated. Likewise, the coupling ensures that the covering element stays in its closed state when the vehicle is in motion.

According to another preferred embodiment of the exterior door handle, provision can be made that in the opened state, the covering element is completely uncoupled from the actuator, and is situated at a distance from the functional component. This ensures that the user obtains simple, safe and convenient access to the functional component.

According to another preferred embodiment of the exterior door handle, provision can be made that in an intermediate state, in which the covering element is arranged at a distance to the vehicle door, the covering element is coupled with the actuator. This is advantageous in that, even with an unintentional and undesired operation of the operation section of the covering element, for example by rolling through a car wash, the covering element is prevented from moving into the opened state, because in the intermediate state the functional component is still arranged to be at least partially protected behind the covering element.

After operation of the operating section of the covering element, it is possible to automatically switch the state of the covering element, if the actuator switches the covering element from the closed state into the opened state and/or into the intermediate state. The actuator carries out the switching immediately after operating the operating section. If the embodiment of the exterior door handle provides for an intermediate setting, provision can also be made that the user can manually move the covering element from the intermediate setting into the opened setting. With this, depending on the design of the exterior door handle, especially with a force-locked connection of the actuator with the covering element, only a slight force needs to be applied to decouple the covering element from the actuator. In an alternative design of the exterior door handle, the actuator can also directly switch the covering element from the closed state into the opened state, while leaving out the intermediate state, if the actuator and the covering element are merely connected with each other by means of a form-locked connection.

The design of the exterior door handle can be very cost effective and simple if the actuator includes a guidance element with a link arranged therein, in which a spring-supported pushing sleeve is arranged with at least one bar, preferably four bars, the pushing sleeve being operable by a pressure sleeve.

The actuator can function reliably if the actuator includes a guidance element with a link arranged therein, in which a spring-supported pushing sleeve is arranged with at least one bar, the pushing sleeve being operable by a pressure sleeve. Tactile perception is thereby improved when operating the covering element.

Advantageously the covering element can be prevented from flapping, if, in the closed state and in the intermediate state of the covering element, the pressure sleeve is coupled with the covering element. This prevents even an inadvertent touching of the operating section of the covering element from moving same immediately into the opened setting.

The actuator can be of a simple and cost-effective design if the pushing sleeve is connected with a spring element, and—when switching the covering element from the closed state to the intermediate state—the pressure sleeve is moved by the pushing sleeve in the direction of the covering element and, in doing so, pivots the covering element.

According to another preferred embodiment of the exterior door handle, provision can be made that the covering element and the pressure sleeve in the closed state of the covering element are able to be connected with each other in force-locked fashion, especially by means of a catch connection. On the one hand, this ensures that the covering element is safely and reliably connected with the actuator, and—at the same time—the user can disconnect the catch connection, if he wants to move the covering element from the intermediate state into the opened state. This is likewise advantageous if the user wants to move the covering element back again from the opened state into the intermediate state.

The design of the exterior door handle can be configured to be very simple, reliable and cost-effective if the catch connection is configured as a ball catch connection, with a ball on the covering element being able to be connected in force-locked fashion in the closed state with a snap hook arranged on the pressure sleeve. Naturally it is also possible that the ball is arranged on the pressure sleeve and the snap hook is arranged on the covering element.

The user can be shown the optimal position for operating the covering element if the operating section of the covering element has a depression. If the operator presses into the depression, preferably with his finger or thumb, then the user has perfect tactile perception. The spring element of the actuator and, if applicable, of the covering element are adjusted to the position of the depression on the operating section.

The covering element can be very safely, simply and reliably supported, if the covering element is arranged so as to pivot on the vehicle door, especially on the bearing bracket. In doing so, it can furthermore be prevented that the covering element falls off the vehicle door after operation of the operating section.

The covering element can be prevented from flapping when the vehicle is in motion if a spring element is assigned to the covering element which holds the covering element in the closed state.

According to a further preferred embodiment provision can be made that the functional component can be configured as a lock cylinder or as a camera unit or as an NFC element. These components must be permanently protected from external environmental influences. The NFC element can be configured as a coil and used in an emergency starter function and/or emergency opening function. The lock cylinder can be operated with a corresponding emergency key to open the vehicle. The camera unit can be used when maneuvering into a parking place, especially when the covering element is in the intermediate state.

When the vehicle is in motion, aerodynamic noise can be reduced if at least the covering element, in a closed state, is arranged to be essentially flush with an outer skin structure, especially an outer plate, of the vehicle door. With this arrangement, it is extremely important that the covering element can only be moved by operating the operating section. With a so-called surface-flush arrangement of the covering element, there are no access surface for a tool or the shaft of a wrench, to move same without damage from the closed state.

Aerodynamic noise during travel can further be reduced if the exterior door handle is configured as a surface-flush exterior door handle, being arranged flush to the exterior skin in an idle position of the exterior door handle, especially to the exterior sheet, of the vehicle door, and in an operating setting of the exterior door handle the outer surface of the exterior door handle being at a distance to the outer skin, especially to the outer sheet, of the vehicle door.

The exterior door handle is described in greater detail by means of an embodiment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure. The figures show:

FIGS. 1a-1c illustrate an exterior door handle with a covering element in various states in views from the front, in accordance with the principles of the present disclosure;

FIG. 2 illustrates an actuator for moving the covering in a view from the front;

FIG. 3 illustrates a pressure sleeve of the actuator in the view from the front;

FIG. 4 illustrates a guide tube of the actuator in the view from the front;

FIG. 5 illustrates a pushing sleeve of the actuator in the view from the front; and

FIGS. 6a-6j illustrate the covering element and the inner view of the actuator in various states of the covering element.

### DETAILED DESCRIPTION

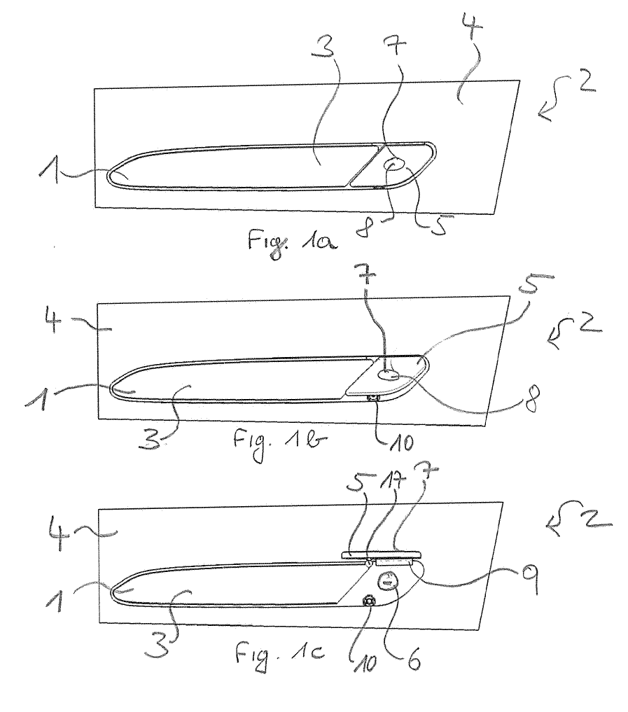

FIGS. 1a-1c show an exterior door handle 1 for a motor vehicle, which is arranged on a vehicle door 2 of the motor vehicle. In the present instance this is a surface-flush exterior door handle 1. In the inoperative position of exterior door handle 1, an outer surface 3 of exterior door handle 1 is essentially flush to an outer skin 4, especially to an outer plate, of vehicle door 2. In an operational position of exterior door handle 1, however, the outer surface of exterior door handle 1 is at a distance to outer skin 4, especially to the outer plate, of vehicle door 2. Additionally, exterior door handle 1 includes a covering element 5, which is arranged on vehicle door 2, especially on a bearing bracket attached to vehicle door 2 that is not shown in greater detail.

A functional component 6, configured as a lock cylinder, is assigned to the vehicle, especially to exterior door handle 1. Said functional component 6 can alternatively also be configured as an NFC element or as a camera unit. The preferably passive NFC element could for example serve for locking and/or unlocking of a lock of vehicle door 2. In doing so, a user could hold up a mobile phone or a smart phone with an NFC chip to covering element 5, to perform the locking and/or unlocking process. In its closed state, covering element 5 essentially is arranged flush to the outer skin 4, especially the outer sheet, of vehicle door 2. Functional component 6 is covered by cover element 5, especially by a recess 14 of cover element 5, to protect this 5 among other things from environmental influences, and to provide a unitary design to exterior door handle 3. In the closed state of covering element 5, functional component 6 descends into recess 14.

Additionally, covering element 5 has an operating section 7 visible from outside for a user, which in the present embodiment is configured as a depression 8. In the closed state of covering element 5, disclosed in FIG. 1a, functional component 6 is arranged to be inaccessible to the user, and in an opened state of covering element 5, depicted in FIG. 1c, functional component 6 is accessible to a user. To switch covering element 5 from one state to another state, covering element 5 is pivoted so as to swivel on vehicle door 2, especially on the bearing handle, on an axis 9. Additionally, an axial spring element, not depicted in greater detail, can be assigned to covering element 5, which element holds covering element 5 in the closed state. On vehicle door 2, especially on the bearing handle, an actuator 10 is arranged, which is provided for moving covering element 5. Along with the closed state of covering element 5 (see FIG. 1a), in which actuator 10 is coupled with covering element 5, and the opened state of covering element 5 (see FIG. 1c), in which actuator 10 is completely uncoupled from covering element 5, there also exists an intermediate state (see FIG. 1b), in which covering element 5 can be arranged at a distance to vehicle door 2, especially to the bearing handle, with actuator 10 then still being able to be coupled with covering element 5.

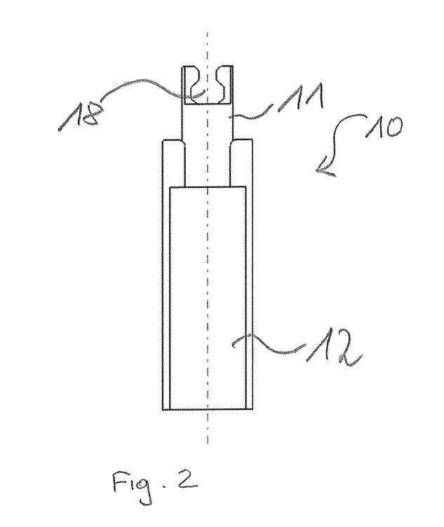

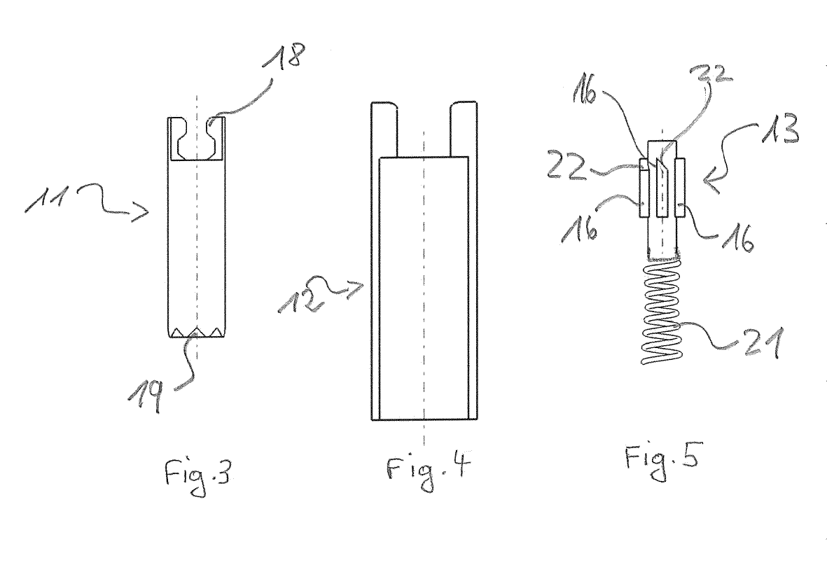

The actuator 10 depicted in greater detail in FIG. 2, essentially comprises a pressure sleeve 11 depicted in FIG. 3, a guidance element 12 shown in FIG. 4, and a pushing sleeve 13 visualized in FIG. 5, which is connected with a spring element 14. Guide element 12 comprises a link 15, in which said spring-supported pushing sleeve 13 having bars 16 is arranged, with pushing sleeve 13 being able to be operated by pressure sleeve 11. Covering element 5 and pressure sleeve 11 are connected to each other in form-locked fashion in the closed state of covering element 5, especially by means of a detachable catch connection. The catch connection can be configured as a ball catch connection, with a ball 17 on covering element 5 being connected in force-locked fashion with a snap hook 18 arranged on pressure sleeve 11 in the closed state of covering element 5.

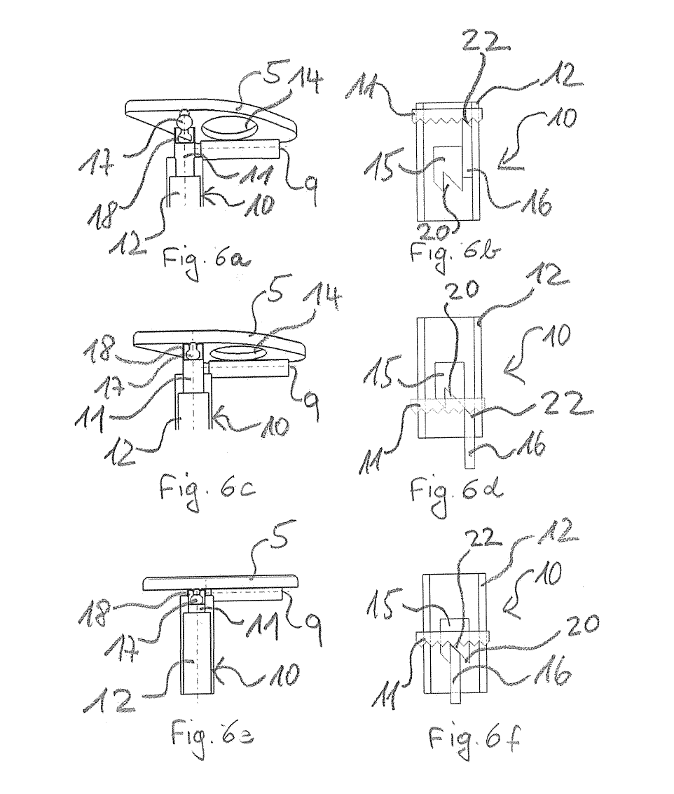

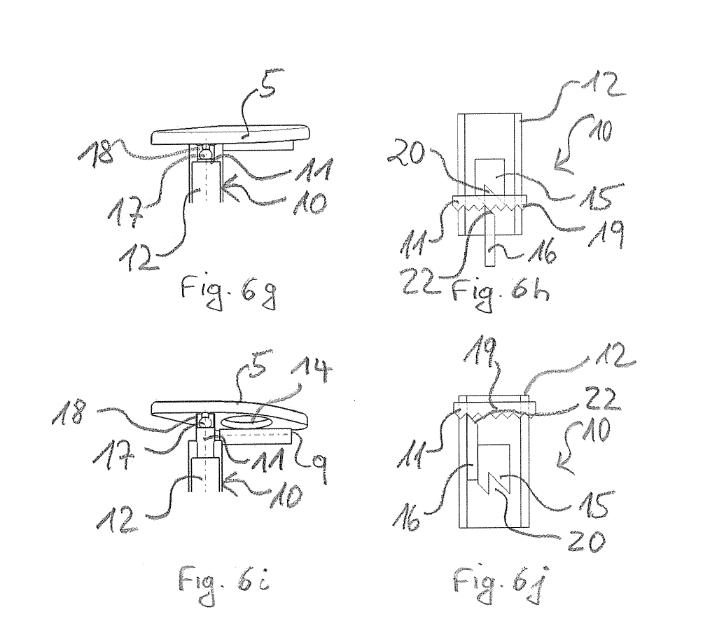

The image sequence of FIGS. 6a-6j describes the functioning of exterior door handle 1, when the user wishes to operate functional component 6 or would like to obtain access to the functional component.

The pairs of FIGS. 6a and 6b, 6c and 6d, 6e and 6f, 6g and 6h, as well as 6i and 6j, each show a specific state of covering element 5, with one Figure of each pair of Figures representing a section of exterior door handle 1 showing covering element 5, and the other Figure of each pair of Figures schematically showing a section of actuator 10.

Consequently, the nearly opened state of covering element 5 is shown in FIG. 6a. Covering element 5 is completely decoupled from actuator 10 and at a distance from functional component 6. Consequently, the ball 17 arranged on covering element 5 is located outside snap hook 18. Contemplating FIG. 6b, the structural design within actuator 10 can be discerned. For better clarification, only one link 15 of guidance element 12 is depicted in detail. Depending on the size of guidance element 12, being configured as a guide tube, for example, multiple links 15 may be arranged. Likewise, only one section of pressure sleeve 11 is shown, in FIG. 6a, especially a sawtooth contour 19 arranged in guidance element 12, which is in engagement with a bar 16 of pushing sleeve 13. Pressure sleeve 11 preferably has four bars 16, which are arranged spaced apart from each other. If the user now wishes to switch covering element 5 into the intermediate state, in which covering element 5 is coupled with pressure sleeve 11, he will make a manual motion, especially pressing with his finger or thumb on operating section 7 of covering element 5, and exert a force on it, so that covering element 5, especially ball 17, is received by snap hook 18. In this move, pressure sleeve 11 is already moved downward and shifts spring-supported pushing sleeve 13, having bar 16, downwards. Sawtooth contour 19 of pressure sleeve 11 still is engaged with bar 16 of pushing sleeve 13. Bar 16, however, is guided past link 15. In FIG. 6d, bar 16 is currently in the position in which it will soon be inserted into a recess 20 of link 15. Pushing sleeve 13 is connected with an additional spring element 21, as is depicted in FIG. 5. Due to a slant 22 on bar 16, as well as due to an additional slant 23 on link 15, and due to the spring force acting on pushing sleeve 13, which is caused by the additional compressed spring element 21, bar 16 drops into recess 20 of the link, as is visualized in FIG. 6f. Thereafter, cover element 5 is in the closed state (see FIG. 6e).

If the user wishes to bring covering element 5 back into the intermediate state, he will manually press with his hand, especially with his finger or thumb, on operating section 7 of covering element 5 and exert a force thereon. In doing so, covering element 5 is compressed further downwards (FIG. 6g). When switching covering element 5 from the closed state, shown in FIG. 6e, into the intermediate state, shown in FIG. 6i, pressure sleeve 11 is moved from pushing sleeve 13 in the direction of cover element 5. As can easily be perceived in FIG. 6h, sawtooth contour 19 of bar 16 is pressed out of recess 20. In FIG. 6h, bar 16 is currently in a transitional position, in which it will soon drop at a slant along link 15 upwards. Since bar 16 is arranged on pushing sleeve 13, and the pushing sleeve is connected with spring element 21, which is compressed together in the setting as per FIGS. 6g and 6h, pushing sleeve 13 and thus also bar 16 is moved upwards, so that covering element 5 is switched into the intermediate state. In doing so, covering element 5 is pivoted. The user pulls on covering element 5 and loosens ball 17 from snap hook 18, so that covering element 5 is subsequently fully uncoupled from actuator 10 and is arranged at a distance from functional component 6.

The foregoing description has been provided for purposes of illustration and description and is not limited to a surface-flush exterior door handle 1. The foregoing description can also be applied to pull handles and fold-up handles, which are at least in part arranged spaced apart from the outer skin of vehicle door 2.

### LIST OF REFERENCE SYMBOLS

1 exterior door handle
2 vehicle door
3 outer surface of exterior door handle 1
4 outer skin of vehicle door 2
5 covering element
6 functional component
7 operating section of covering element 5
8 depression
9 axis
10 actuator
11 pressure sleeve
12 guidance element
13 pushing sleeve
14 recess
15 link
16 bar
17 ball
18 snap hook
19 sawtooth contour
20 recess
21 additional spring element
22 slant
23 additional slant

1. An exterior door handle for a motor vehicle, the door handle comprising:
a functional component, which is able to be covered by a covering element, the covering element being arranged on a bearing bracket connected to a motor vehicle door, the covering element having an operating section visible from outside to a user, wherein in a closed state of the covering element the functional component is inaccessible to the user and in an opened state of the covering element the functional component is accessible to a user; and
an actuator arranged on the bearing bracket and configured to move the covering element, wherein the operating section in the closed state of the covering element can be operated by the user for activation of the actuator.

2. The exterior door handle according to claim 1, wherein the covering element is coupled with the actuator, at least in the closed state.

3. The exterior door handle of claim 1, wherein the covering element is completely uncoupled from the actuator in the opened state and is arranged spaced apart from the functional component.

4. The exterior door handle according to claim 1, wherein in an intermediate state in which the covering element is spaced apart from the motor vehicle door, the covering element is coupled with the actuator.

5. The exterior door handle according to claim 1, wherein the actuator switches the covering element from the closed state into the opened state and/or into an intermediate state.

6. The exterior door handle according to claim 1, wherein the actuator comprises a guidance element with a link arranged therein, in which a spring-supported pushing sleeve is arranged with at least one bar, the pushing sleeve being able to be operated by a pressure sleeve.

7. The exterior door handle according to claim 6, wherein, in the closed state and in an intermediate state of the covering element, the pressure sleeve is coupled with the covering element.

8. The exterior door handle according to claim 6, wherein the pushing sleeve is connected with a spring element and when switching the covering element from the closed state into an intermediate state, the pressure sleeve is moved from the pushing sleeve in the direction of the covering element and the covering element is pivoted.

9. The exterior door handle according to claim 6, wherein the covering element and the pressure sleeve are able to be connected with each other in force-locked fashion by a catch connection in the closed state of the covering element.

10. The exterior door handle according to claim 9, wherein the catch connection is configured as a ball catch connection having a ball operable to be joined in force-locked fashion on the covering element with a snap hook arranged on the pressure sleeve.

11. The exterior door handle according to claim 1, wherein the operating section of the covering element has a depression.

12. The exterior door handle according to claim 1, wherein the covering element is arranged to be pivotable on the bearing bracket.

13. The exterior door handle according to claim 1, wherein a spring element is assigned to the covering element, the spring element holding the covering element in the closed state.

14. The exterior door handle according to claim 1, wherein the functional component is configured as a lock cylinder or as a camera unit or as an NFC element.

15. The exterior door handle according to claim 1, wherein at least the covering element in the closed state is arranged flush to an outer sheet of the motor vehicle door.

16. The exterior door handle according to claim 1, wherein the exterior door handle is configured as a surface-flush exterior door handle, wherein in an inoperative position of the exterior door handle an outer surface of the exterior door handle is arranged flush to an outer sheet of the motor vehicle door and in an operational position of the exterior door handle the outer surface of the exterior door handle is arranged spaced apart from the outer sheet of the motor vehicle door.
